(19) United States
(12) Patent Application Publication
(10) Pub. No.: US 2012/0042179 A1
(43) Pub. Date: Feb. 16, 2012

(54) Server Machine, Power-Consumption Control Method, and Network System

(75) Inventor: Nobuhiro Tamura, Nagoya-shi (JP)

(73) Assignee: BUFFALO INC., Nagoya-shi (JP)

(21) Appl. No.: 13/205,647

(22) Filed: Aug. 9, 2011

(30) Foreign Application Priority Data
Aug. 11, 2010 (JP) 2010-180341

(51) Int. Cl. G06F 1/26

(52) U.S. Cl. 713/300

(57) ABSTRACT

A server machine according to the present invention includes: one or more ports each connectable to a separate peripheral device; at least one communication section connectable to a network in plural types of communications mode differentiated according to communications rate and each differing in power consumption required for communications; and a setting section for, based on at least the respective power consumptions in the communications modes and on the sum of the highest-speed data transmission rates of each peripheral device connected to the one or more ports, choosing one of the communications modes and setting the communication section into the chosen communications mode.

### CROSS REFERENCE TO RELATED APPLICATION

The disclosure of Japanese Patent Application No. 2010-180341, filed on Aug. 11, 2010, is incorporated herein by reference.

### BACKGROUND OF THE INVENTION

1. Field of the Invention

The present invention relates to server machines.

2. Description of the Background Art

Device servers, server machines for connecting peripheral devices and a host computer via a network and relaying communications between the devices and the computer, are known. Meanwhile, power economizing in such device servers is being proposed. For example, the device server disclosed in Japanese Laid-Open Patent Publication No. 2007-310796, by making its manual connection to a host computer, its receiving of USB protocol based data, or another event a trigger supplies bus power to a USB device, as a peripheral device connected to the device server, only when the USB device is being used, thereby realizing power economization. However, it can happen that the network-side interface in order for a device server to make connection to a host computer is, irrespective of necessity, connected with the host computer at the highest-speed communications rate or at a communications rate greater than necessary. As a result, network-side interfaces have consumed power wastefully.

### SUMMARY OF THE INVENTION

The present invention has been made to solve the conventional problems described above, and an object of the present invention is to suppress power consumed in a server machine for communicating with a host computer.

A first aspect of the present invention is a server machine comprising: one or more ports each connectable to a separate peripheral device; at least one communication section connectable to a network in plural types of communications mode differentiated according to communications rate and each differing in power consumption required for communications; and a setting section for, based on at least the respective power consumptions in the communications modes and on the sum of the highest-speed data transmission rates of each peripheral device connected to the one or more ports, choosing one of the communications modes and setting the communication section into the chosen communications mode.

Preferably, in the communications mode of the faster communications rate, the power consumption is greater. In addition, if among the plural types of communications mode is a communications mode that is not the communications mode whose communications rate is fastest and yet has a communications rate greater than the sum of the highest-speed data transmission rates of each peripheral device connected to the one or more ports, the setting section sets the communication section into said communications mode that is not the communications mode whose communications rate is fastest.

Preferably, in the server machine, the setting section sets the communication section into that communications mode whose power consumption is smallest among communications modes having a communications rate greater than the sum of the highest-speed data transmission rates of each peripheral device connected to the one or more ports.

Preferably, in the server machine, the setting section performs communications-mode setting at least when a peripheral device is either connected to or is disconnected from one of the server machine's ports.

Preferably, in the server machine, the setting section calculates the highest-speed data transmission rate of each peripheral device connected to the one or more ports, based on class of peripheral device, each being differentiated according to data transmission rate at which the peripheral device is capable of transmitting data.

Preferably, in the server machine, the one or more ports are USB interfaces.

Preferably, the server machine is furnished with a plurality of the communication sections, whereby the server machine is connectable to a plurality of networks, and the setting section sets each communication section uniformly into the same communication mode.

It is noted that the present invention can be realized in a variety of modes. For example, the present invention can be realized as: a power consumption control method; a power consumption control apparatus; an integrated circuit or a computer program for realizing the function of such a method or an apparatus; or a storage medium having stored therein such a computer program.

According to the present invention, it is possible to suppress power consumed in a server machine for communicating with a host computer.

The present invention is applicable to a server machine or the like, and particularly, is useful for a device server for making connection to a device. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the system configuration of a network system according to an embodiment of the present invention;

FIG. 2 is a diagram showing a flow of communication mode setting processing according to the embodiment of the present invention;

FIG. 3 is a diagram showing another flow of the communication mode setting processing according to the embodiment of the present invention;

FIG. 4 is a diagram showing a reference table according to the embodiment of the present invention; and

FIG. 5 is a state transition diagram showing the change in the communication mode according to the embodiment of the present invention.

### DESCRIPTION OF THE PREFERRED EMBODIMENTS

### Embodiments

Hereinafter, embodiments of the present invention will be described.

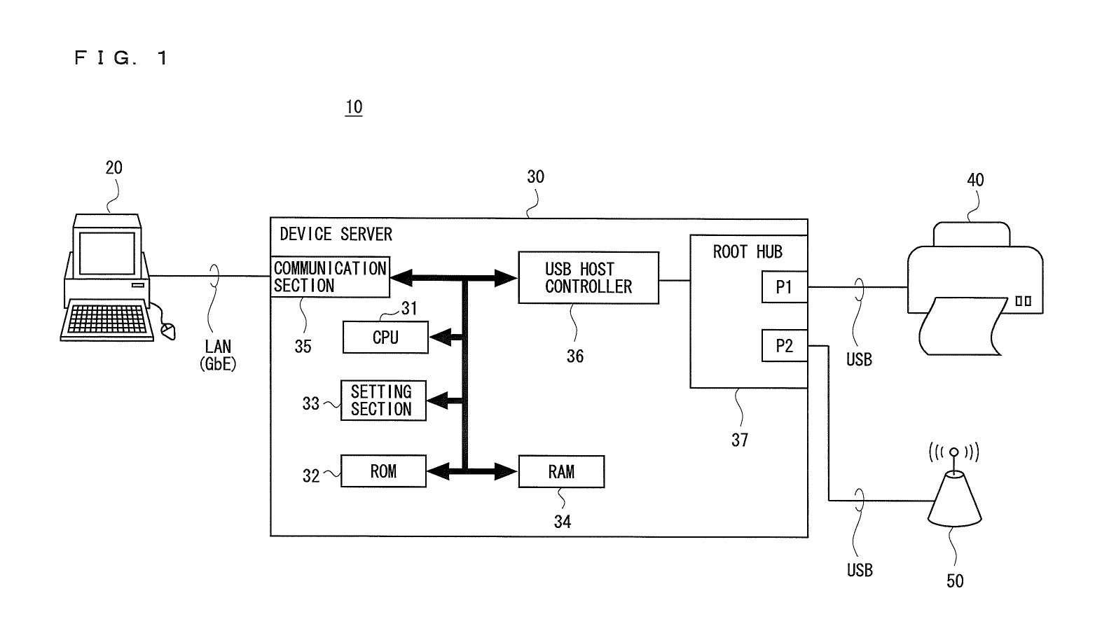

The first embodiment of the present invention will be described. FIG. 1 is a schematic diagram showing the system configuration of a network system 10 according to the present embodiment. The network system 10 includes a computer 20 which is a host computer, a device server 30 which is a server machine, a printer 40, and a television tuner 50. The computer 20 and the device server 30 are connected to each other via a wired LAN (local area network) compliant with Ethernet (registered trademark) standard. In addition to the computer 20, a plurality of computers may be connected to the LAN. Ethernet used in the present embodiment is, for example, 1000BASE-T standard, which is Gigabit Ethernet (GbE) whose maximum communication rate is 1 Gbps (gigabits per second).

The printer 40 and the television tuner 50 are an example of peripheral equipment in the present embodiment. The device server 30 and the printer 40, and the device server 30 and the television tuner 50 are connected by USB (universal serial bus). The printer 40 is a general ink-jet printer. The printer 40 receives printing image data outputted by the computer 20, from the computer 20 via the device server 30, and prints an image on a printing medium, based on the received printing image data. A USB interface included in the printer 40 is compliant with USB 1.1 standard, for example. The printer 40 is a full-speed device (hereinafter, also referred to as an FS device) whose maximum data transmission rate is 12 Mbps (megabits per second).

Here, classification of the standards of USB devices according to their data transmission rates will be described. The USB devices are classified into four types of a low-speed device (hereinafter, also referred to as an LS device), a full-speed device (hereinafter, also referred to as an FS device), high-speed device (hereinafter, also referred to as an HS device), and a super-speed device (hereinafter, also referred to as an SS device), in accordance with their data transmission rates. The maximum data transmission rates of the LS device, the FS device, the HS device, and the SS device are 1.5 Mbps, 12 Mbps, 480 Mbps, and 5 Gbps, respectively. In this way, the USB devices are classified. It is noted that, among USB standards, USB 1.0 and USB 1.1 support up to a data transmission rate of 12 Mbps, USB 2.0 supports up to a data transmission rate of 480 Mbps, and USB 3.0 supports up to a data transmission rate of 5 Gbps.

The television tuner 50 receives a digital terrestrial broadcasting signal which is a radio signal for television broadcasting, and transmits the received signal to the computer 20 via the device server 30, whereby a television broadcast can be watched on the computer 20. A USB interface included in the television tuner 50 is compliant with USB 2.0 standard. The television tuner 50 is an HS device whose maximum data transmission rate is 480 Mbps. Although in the present embodiment, the television tuner 50 is a device receiving a digital terrestrial broadcasting signal, the television tuner 50 may be a device receiving an analog broadcasting signal. It is noted that, hereinafter, the printer 40 and the television tuner 50 are referred to as peripheral equipment.

The device server 30 is a server machine for relaying communication between at least one peripheral device, and the computer 20 functioning as a host computer. As described above, the device server 30 is connected to the computer 20 by Ethernet, and is connected to peripheral equipment by USB. The device server 30 includes a CPU 31, a ROM 32, a RAM 34, a communication section 35, a USB host controller 36, a root hub 37, and a setting section 33. The CPU 31 loads a program (control program) for performing overall control of the device server 30, from the ROM 32, and executes the program, to control the overall operation of the device server 30. That is, the components of the device server 30 are controlled by the CPU 31. The ROM 32 is a memory such as a flash ROM.

The RAM 34 is, for example, a DDR2-SRAM, and is used as a main memory for the CPU 31 to perform calculation processing. The communication section 35 includes a LAN port. The communication section 35 is a connection interface (LAN/IF) for making connection to a LAN. The USB host controller 36 is a dedicated device for controlling transmission and reception of data in USB connection. In the present embodiment, the USB host controller 36 includes an ASIC (application specific integrated circuit) as an example. The device server 30 includes a root hub 37 having a connection port P1 and a connection port P2 for enabling connection to a plurality of peripheral devices. The root hub 37 is connected with the USB host controller 36. As shown in FIG. 1, the connection port P1 is connected to the printer 40, and the connection port P2 is connected to the television tuner 50. In addition, in the present embodiment, the USB host controller 36 and the root hub 37 are compliant with USB 3.0 standard. The setting section 33 will be described later.

Next, communication mode setting processing performed by the network system 10 will be described. The communication mode setting processing chooses and sets a communication mode, for the network, in which the device server 30 and the computer 20 are connected, in accordance with the state of connection between the device server 30 and the peripheral equipment.

Such communication modes are classified based on communication rates in connection between the device server 30 and the network. As described above, Ethernet used in the present embodiment is Gigabit Ethernet (GbE). The device server 30 has three communication modes for Gigabit Ethernet. Specifically, the device server 30 is capable of performing communication in three communication modes including a communication mode of 1000BASE-T whose communication rate is 1 Gbps, a communication mode of 100BASE-T whose communication rate is 100 Mbps, and a communication mode of 10BASE-T whose communication rate is 10 Mbps. Hereinafter, the names of standards such as “1000BASE-T” and “100BASE-T” are used as the names of the communication modes. In general, the larger the communication rate is, the larger power consumed in communication by the device server 30 is. Also in the present embodiment, the device server 30 has a correlation in which the larger the communication rate of the communication mode is, the larger the power consumption is.

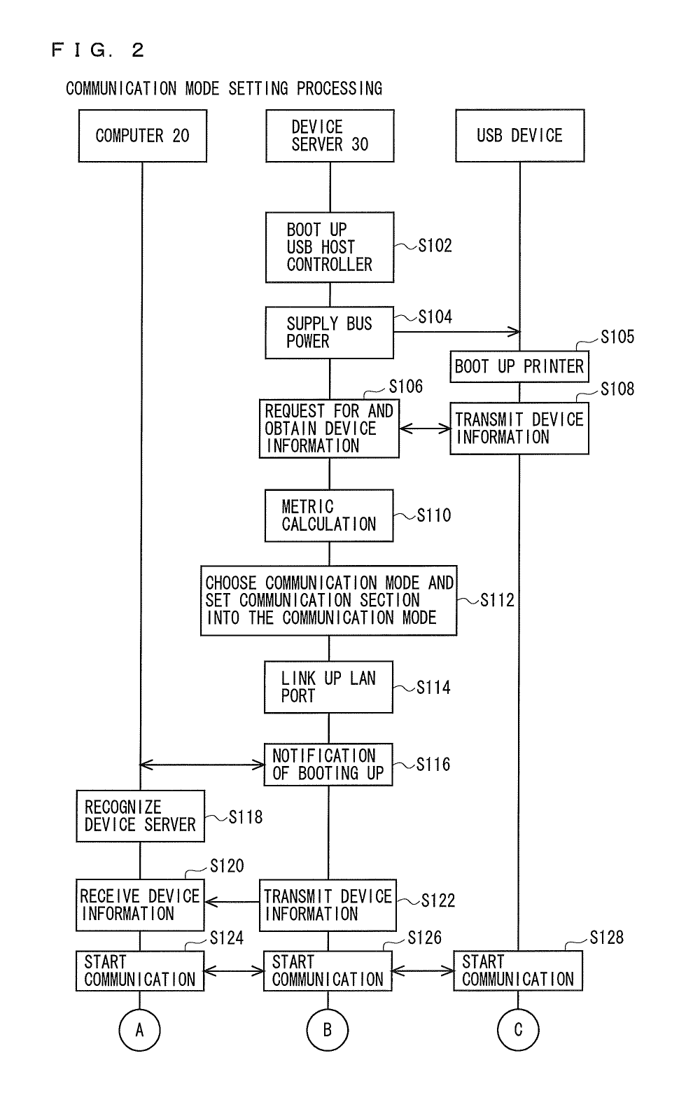

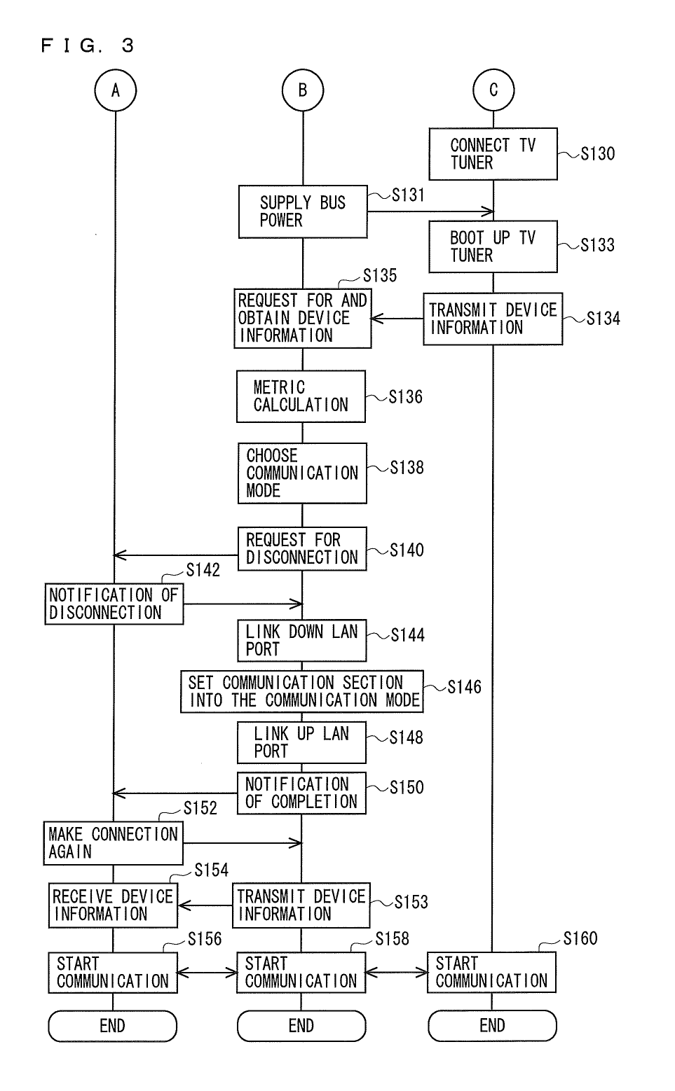

FIG. 2 and FIG. 3 are diagrams showing flows of the communication mode setting processing performed by the device server 30. In the present embodiment, as an example, it will be assumed that the printer 40 has been already connected to the connection port P1 of the device server 30 in an initial state, and thereafter, the television tuner 50 is newly connected to the connection port P2. In addition, it will be assumed that the communication mode is 10BASE-T in the initial state. In FIG. 2 and FIG. 3, the printer 40 and the television tuner 50 are collectively referred to as “peripheral equipment”.

The communication mode setting processing is started by a user powering on and booting up the computer 20 and the device server 30. When the processing has been started, the device server 30 boots up the USB host controller 36 (step S102), and attempts to supply power to peripheral equipment connected to the connection ports P1 and P2, via Vbus terminals (hereinafter, simply referred to as Vbus) of the connection ports P1 and P2 (step S104). In the present embodiment, the printer 40 is connected to the connection port P1 in the initial state of the network system 10. Therefore, power is supplied to the printer 40 via Vbus, and the printer 40 is booted up (step S105).

Thereafter, the device server 30 transmits a request for USB device information to the peripheral device connected to the connection port, to cause the peripheral device to transmit the USB device information, and obtains the transmitted USB device information (step S106 and step S108). Specifically, the USB device information includes, for example, a device name for identifying the peripheral device, and information about which the peripheral device is, an LS device, an FS device, an HS device, or an SS device. In the present embodiment, the CPU 31 obtains the USB device information from the printer 40 connected to the connection port P1.

Next, the device server 30 performs metric calculation. Specifically, after the USB device information is obtained, the CPU 31 controls the setting section 33 to calculate the sum of the maximum transmission rates of the respective peripheral devices connected to the device server 30 (step S110). The metric calculation is performed based on expression (1). The calculated value of the metric calculation is referred to as a summation value Y.

Summation value Y=1.5a+12b+480c+5000d (1)
a: LS device connection number
b: FS device connection number
c: HS device connection number
d: SS device connection number

In expression (1), a, b, c, and d represent the numbers of the respective types of peripheral equipment connected to the device server 30, that is, the numbers of LS devices, FS devices, HS devices, and SS devices, respectively. “1.5”, “12”, “480”, and “5000” which are coefficients of a, b, c, and d represent the maximum data transmission rates of the respective types of peripheral equipment with a unit of “Mbps”. That is, the summation value Y calculated by expression (1) represents the sum of the maximum data transmission rates of the respective peripheral devices connected to the device server 30, with a unit of Mbps.

In the present embodiment, the device server 30 supports USB 3.0, and therefore also supports the transmission rate of SS devices which have the fastest data transmission rate. However, for example, in the case where the device server 30 supports only USB 1.0 and USB 1.1, the supported data transmission rate is 12 Mbps. Therefore, even when an HS device and an SS device are connected as the peripheral equipment, the maximum data transmission rates thereof become 12 Mbps. Therefore, in this case, the coefficients of c and d in expression (1) are also “12”. That is, the actual maximum data transmission rate is determined by both the data transmission rate of the device server 30 and the data transmission rate of each of the peripheral device. In the present embodiment, the maximum data transmission rate determined based on both the device server 30 and the peripheral equipment is referred to as a “maximum data transmission rate”.

Here, as the initial state, only the printer 40 is connected to the device server 30. As described above, the printer 40 is an FS device. Therefore, a, b, c, and d in expression (1) are determined as a=0, b=1, c=0, and d=0, and the summation value Y is calculated as Y=12×1=12, by metric calculation.

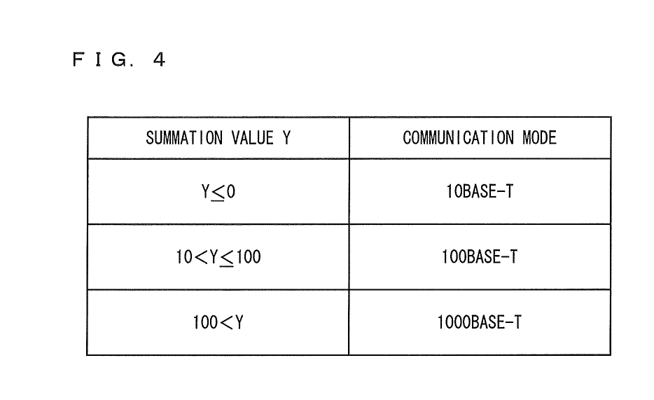

After the summation value Y is calculated, the device server 30 chooses and sets the communication mode for making connection to the computer 20, in accordance with the summation value Y (step S 112). FIG. 4 is a diagram showing an example of a reference table indicating communication modes that the device server 30 chooses in accordance with the summation value Y. In FIG. 4, the left column indicates values of the summation value Y, and the right column indicates communication modes corresponding to the respective values. Here, the summation value Y is 12, and therefore, according to the reference table, the communication mode to be chosen is 100BASE-T. The communication mode of the device server 30 has been set at 10BASE-T, in the initial state after the device server 30 is powered on. Therefore, here, the device server 30 changes and sets the communication mode from 10BASE-T to 100BASE-T in accordance with the reference table, links up the LAN port (step S114), and transmits a notification of booting up of the device server 30 to the computer 20 (step S116).

The computer 20 that has received the notification of booting up recognizes the device server 30 (step S118). Thereafter, the computer 20 obtains the USB device information about the peripheral device connected to the device server 30, which is transmitted from the device server 30 (step S120 and step S122). Thereafter, the computer 20 starts to communicate with the printer 40 via the device server 30 (step S124, step S126, and step S128). At this time, as described above, the computer 20 and the device server 30 are connected to each other in the communication mode of 100BASE-T.

Next, processing performed when a peripheral device is newly connected to the device server 30 after the device server 30 is booted up, will be described. In the present embodiment, the user connects the television tuner 50 to the connection port P2 of the device server 30 (step S130 in FIG. 3). The device server 30 causes the USB host controller 36 to start to supply power to the television tuner 50 via Vbus of the connection port P2 (step S131). As a result, the television tuner 50 is booted up (step S133). Thereafter, the device server 30 requests for USB device information about the television tuner 50, and obtains the USB device information (step S134 and step S135). Then, the device server 30 performs metric calculation for calculating the sum of the maximum data transmission rates of the respective peripheral devices connected to the device server 30, based on the USB device information obtained from the television tuner 50, and on the USB device information that has been already obtained from the other peripheral device connected to the device server 30 (step S136). Here, in the device server 30, the printer 40 which is an FS device is connected to the connection port P1, and the television tuner 50 which is an HS device is connected to the connection port P2. Therefore, a, b, c, and d in expression (1) are determined as a=0, b=1, c=1, and d=0. Therefore, the metric calculation based on expression (1) results in Y=12×1+480×1=492.

After the summation value Y is calculated, the device server 30 chooses the communication mode corresponding to the summation value Y in accordance with the reference table (step S138). As a result, the communication mode is chosen as 1000BASE-T. After the communication mode is chosen, the device server 30 transmits a request for disconnection to the computer 20 (step S140). The computer 20 transmits a confirmation of disconnection to the device server 30 in response to the request for disconnection (step S142). Thereafter, the device server 30 links down the LAN port (step S144), terminates the network connection to the computer 20, changes and sets the communication mode from 100BASE-T to 1000BASE-T (step S146), and links up the LAN port again (step S148).

Then, the device server 30 transmits a notification of completion to the computer 20 (step S150), and the computer 20 makes connection again in response to the notification of completion (step S152). The computer 20 obtains USB device information about the television tuner 50, which is transmitted from the device server 30 (step S153 and step S154). Thereafter, the computer 20 is connected to the television tuner 50 and the printer 40 via the device server 30, and starts to communicate with them (step S156, step S158, and step S160). At this time, as described above, the computer 20 and the device server 30 are connected in the communication mode of 1000BASE-T.

In addition, if a peripheral device is detached, that is, disconnected from the connection port P1 or P2 of the device server 30, the device server 30 detects the disconnection and executes processing of steps S136 to S150. For example, in the case where the television tuner 50 is detached to terminate the connection from the state in which the printer 40 and the television tuner 50 are connected to the device server 30, the communication mode is changed and set from 1000BASE-T to 100BASE-T, based on the maximum communication rate of the printer 40 connected to the device server 30, in the communication mode setting processing. In the case where all peripheral devices are detached from the connection ports, for example, the device server 30 executes processing of steps S140 to S144 to link down the LAN port. In this way, the device server 30 performs the communication mode setting processing.

It is noted that if the communication mode is not changed as a result of the metric calculation, the device server 30 may omit processing of steps S138 to S150.

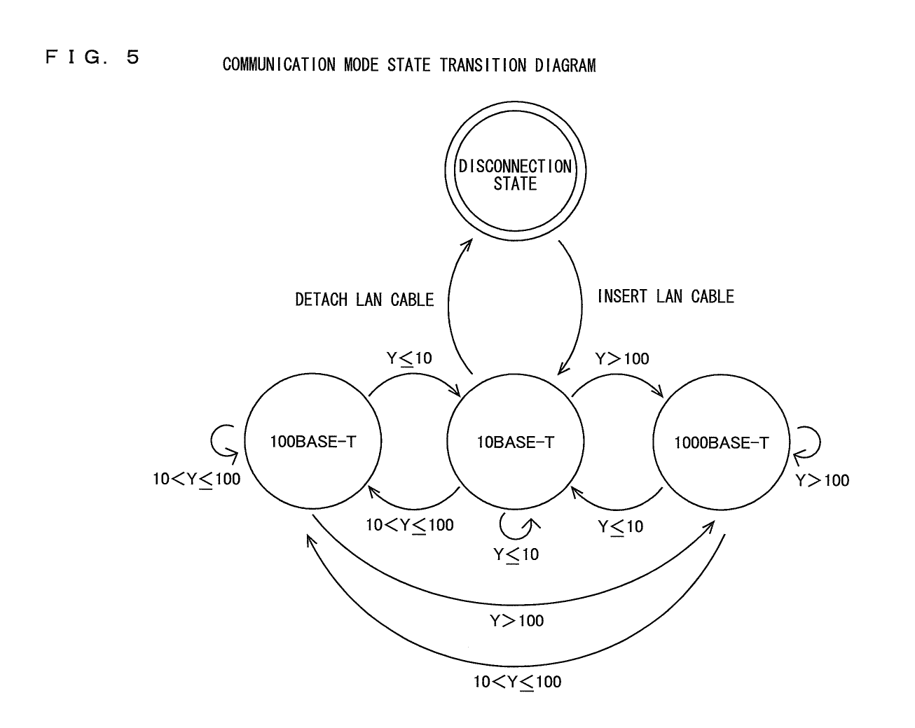

FIG. 5 is a communication mode state transition diagram showing the change in the communication mode according to the change in the summation value Y. For example, if the LAN cable is connected to the device server 30 from the state in which the LAN cable is not connected to the device server 30 (disconnection state), first, the communication mode is set at 10BASE-T. From this state in which the communication mode is 10BASE-T, if the printer 40 (which is an FS device and has the maximum data transmission rate of 12 Mbps) and the television tuner 50 (which is an HS device and has the maximum data transmission rate of 480 Mbps) are connected to the connection port P1 and the connection port P2 substantially at the same time, respectively, the summation value Y satisfies Y>100, and the communication mode is changed to 1000BASE-T. From this state, if the television tuner 50 is detached from the connection port P2, the summation value Y satisfies 10<Y≦100, and the communication mode is changed to 100BASE-T. In this manner, every time the summation value Y changes owing to connection or disconnection of peripheral equipment with the connection ports, the communication mode is changed in accordance with the summation value Y.

As described above, the device server 30 changes the communication mode such that the communication mode has a communication rate in the range of communication rate needed on the network side for making connection to the computer 20, in accordance with the connection state of the peripheral equipment connected to the device server 30, that is, more specifically, in accordance with the sum of the maximum data transmission rates of the respective peripheral devices connected to the device server 30. As a result, since the device server 30 does not perform the link-up at a communication rate excessively larger than the summation value Y, consumption of excessive power for keeping a communication rate more than necessary is prevented. Therefore, it becomes possible to realize power saving, in comparison with, for example, the case where connection is always made at the maximum communication rate. In addition, in the case where any peripheral equipment is not connected to the connection port P1 or the connection port P2, power consumption is suppressed if the LAN port is not linked up, for example.

In the case where Gigabit Ethernet standard is used in the network, the number of signal lines used in transmission and reception of a signal is different between, for example, 100BASE-T and 1000BASE-T. In 100BASE-T, one-transmission/one-reception communication is performed, and one pair of (two) signal lines are used for one transmission or one reception. Therefore, one voltage signal is needed for each of a total of four signal lines. That is, power for four signals is needed to be supplied. On the other hand, in 1000BASE-T, four-transmission/four-reception communication is performed, and one transmission and one reception are performed per one signal line (that is, two-way communication). Therefore, two signals are needed for each of a total of eight signal lines, that is, power for a total of sixteen signals are needed. Therefore, if the power consumption is approximately calculated from the number of signals that are needed in each of 100BASE-T and 1000BASE-T, the power consumption in 1000BASE-T is about four times as large as that in 100BASE-T. Therefore, the effect of power saving obtained by suppressing the communication rate to keep it within the range needed by the device server 30 is significantly great. In addition, power saving of the computer 20 can be also realized, because the computer 20 which is connected to the device server 30 via the network also perform communication in the communication mode set by the device server 30, and because it is considered that the computer 20 also has the same correlation between the communication rate and the current consumption as the device server 30.

It is noted that the present invention is not limited to the above embodiment. The present invention may be implemented in various embodiments without departing from the scope of the invention. For example, the following modifications may be conducted.

### First Modification

In the above embodiment, the case where a USB interface is used as an interface for connecting the device server 30 and peripheral equipment has been described. However, the present invention is not limited thereto, and other types of interfaces may be applied. For example, a connection interface compliant with SATA (serial ATA) standard or i-SCSI standard may be applied. In this case, the maximum data transmission rate in communication with each peripheral device is obtained from device information or the like compliant with each standard, which information is received from the peripheral device instead of USB device information. Then, the summation value Y of the obtained maximum communication rates is calculated, and the communication mode is changed and set to a mode corresponding to the summation value Y, whereby the same effect as in the above embodiment can be obtained. In this case, instead of expression (1), a calculation expression corresponding to each standard is used for calculation of the summation value Y.

### Second Modification

In the above embodiment, the case where the communication section 35 of the device server 30 has one LAN port has been described. However, the communication section 35 may have a plurality of LAN ports. In this case, the communication modes of all the LAN ports are uniformly changed and set at the same communication mode corresponding to the summation value Y, based on the same reference table, whereby the same effect as in the above embodiment can be obtained.

### Third Modification

In the above embodiment, the case where the device server 30 has a plurality of connection ports for USB has been described. However, the present invention is applicable even in the case where the device server 30 has only one connection port. That is, the communication mode is set based on the maximum data transmission rate of a USB device connected to the connection port. Even in this manner, the same effect as in the above embodiment can be obtained.

### Fourth Modification

In the above embodiment, the communication mode is set at the time when a peripheral device is connected to or disconnected from the device server 30. However, the present invention is not limited thereto. For example, the summation value Y may be calculated at regular intervals, and if the summation value Y has changed, the setting of the communication mode may be changed at that point of time. This is effective in the case where the maximum data transmission rate of a peripheral device connected to the device server 30 changes owing to a factor such as sleep state or return state other than connection and disconnection. Alternatively, the metric calculation may be performed by defining the sleep state as being substantially a disconnection state, to calculate the summation value Y, or the metric calculation may be performed by defining the sleep state as being a connection state, to calculate the summation value Y. Even in this manner, the same effect as in the above embodiment can be obtained.

### Fifth Modification

In the above embodiment, it is assumed that the power consumption increases as the communication rate increases. However, the present invention is not limited thereto. The communication mode setting processing is applicable even in the case where there is no such correlation between the communication rate and the power consumption. For example, the device server 30 may store in advance a table indicating the correspondence relationship between the communication rate and the power consumption in each communication mode, communication modes having larger communication rates than the summation value Y may be extracted based on the table, and then, among the extracted communication modes, the communication mode indicating the smallest power consumption may be chosen and set, whereby the same effect as in the above embodiment can be obtained.

### Sixth Modification

In the above embodiment, the metric calculation is performed by using information about the classified types of the standards of USB devices (for example, types such as FS device and HS device), which is obtained from the USB device information about the peripheral equipment. However, in the case where information about the actual maximum data transmission rate specific to each peripheral device can be obtained when its device information is obtained, the summation value Y may be calculated by using the actual maximum data transmission rate. Alternatively, the actual data transmission rate needed for each peripheral device may be obtained as the USB device information, and the summation value Y may be calculated by using the actual maximum data transmission rate.

### Seventh Modification

In the above embodiment, since the device server 30 supports USB 1.0 to USB 3.0, the summation value Y is calculated by expression (1). However, for example, in the case where the device server 30 supports USB 1.0 to USB 1.1, since the data transmission rate is up to 12 Mbps, the maximum data transmission rates of the HS device and the SS device become 12 Mbps. Therefore, in this case, the multipliers of c and d in expression (1) also become “12”. That is, the actual maximum data transmission rate is determined by both the data transmission rate of the device server 30 and the data transmission rate of each of the peripheral equipment, and the summation value Y is calculated based on the determined maximum data transmission rates. Even in this manner, the same effect as in the above embodiment can be obtained. In addition, if a new USB standard is created and applied to the device server 30 or the peripheral equipment, the summation value Y can be calculated by adding a term corresponding to the new USB standard to expression (1) as appropriate, whereby the same effect as in the above embodiment can be obtained.

### Eighth Modification

In the above embodiment, among communication modes having larger communication rates than the summation value Y, the communication mode indicating the smallest power consumption is set. However, even if the communication mode indicating the smallest power consumption is not set, the effect of suppressing power consumption in comparison with the case where the communication mode indicating the largest power consumption is kept can be obtained unless the communication mode indicating the largest power consumption is set.

### Ninth Modification

In the above embodiment, the communication mode is 10BASE-T when the communication mode setting processing is started, as shown in FIG. 5. However, the present invention is not limited thereto. The initial communication mode may be 100BASE-T or 1000BASE-T. Alternatively, the communication mode may not be set just after the communication mode setting processing is started. After the communication mode setting processing is started and the summation value Y is calculated, the communication mode may be set.

It is noted that the functions of the components in the above embodiment and the modifications may be realized by software, or may be realized by hardware.

What is claimed is:

1. A server machine comprising:
one or more ports each connectable to a separate peripheral device;
at least one communication section connectable to a network in plural types of communications mode differentiated according to communications rate and each differing in power consumption required for communications; and
a setting section for, based on at least the respective power consumptions in the communications modes and on the sum of the highest-speed data transmission rates of each peripheral device connected to the one or more ports, choosing one of the communications modes and setting the communication section into the chosen communications mode.

2. The server machine according to claim 1, wherein:
in the communications mode of the faster communications rate, the power consumption is greater; and
if among the plural types of communications mode is a communications mode that is not the communications mode whose communications rate is fastest and yet has a communications rate greater than the sum of the highest-speed data transmission rates of each peripheral device connected to the one or more ports, the setting section sets the communication section into said communications mode that is not the communications mode whose communications rate is fastest.

3. The server machine according to claim 1, wherein the setting section sets the communication section into that communications mode whose power consumption is smallest among communications modes having a communications rate greater than the sum of the highest-speed data transmission rates of each peripheral device connected to the one or more ports.

4. The server machine according to claim 1, wherein the setting section performs communications-mode setting at least when a peripheral device is either connected to or is disconnected from one of the server machine's ports.

5. The server machine according to claim 1, wherein the setting section calculates the highest-speed data transmission rate of each peripheral device connected to the one or more ports, based on class of peripheral device, each being differentiated according to data transmission rate at which the peripheral device is capable of transmitting data.

6. The server machine according to claim 1, wherein the one or more ports are USB interfaces.

7. The server machine according to claim 1, furnished with a plurality of the communication sections, whereby the server machine is connectable to a plurality of networks, wherein
the setting section sets each communication section uniformly into the same communication mode.

8. A network system comprising:
the server machine according to claim 1; and
at least one peripheral device connected to the server machine.

9. A power-consumption control method for a server machine connectable to at least one peripheral device, and connectable to a network in plural types of communications mode differentiated according to communications rate and each differing in power consumption required for communications, the power-consumption control method comprising:
a step of, based on at least the respective power consumptions in the communications modes and on the sum of the highest-speed data transmission rates of each peripheral device connected to the server machine, choosing one of the communications modes.
